(19) United States
(12) Patent Application Publication
(10) Pub. No.: US 2003/0013788 A1
(43) Pub. Date: Jan. 16, 2003

(54) Melt polycarbonate with improved resistance to hydrolysis

(76) Inventors: James Mason, Krefeld (DE); Wolfgang Ebert, Krefeld (DE)

Correspondence Address: BAYER CORPORATION, PATENT DEPARTMENT, 100 BAYER ROAD, PITTSBURGH, PA, 15205, US

(21) Appl. No.: 10/104,163

(22) Filed: Mar. 22, 2002

(30) Foreign Application Priority Data
Mar. 26, 2001 (DE) 10114807.0
May 10, 2001 (DE) 10122495.8

(51) Int. Cl. C08L 1/00

(52) U.S. Cl. 524/120

(57) ABSTRACT

A molding composition containing melt polycarbonate conforming to a specific formula is disclosed. The composition that additionally contains a phosphorous compound is characterized in its improved resistance to hydrolysis.

### FIELD OF THE INVENTION

The invention relates to polycarbonates and more particularly to melt polycarbonates having improved resistance to hydrolysis.

### BACKGROUND OF THE INVENTION

Polycarbonate is produced industrially using the interface process or by transesterification in the melt (melt polymerization process). The melt polymerization process is gaining in interest because it may be performed without the use of phosgene or chlorinated solvents. The interface process produces a polycarbonate with exceptional color and resistance to hydrolysis. It is known that additives based on phosphorus may be added to the polycarbonate in order to further improve the color. However, adding these phosphorus compounds lowers the resistance to hydrolysis of polycarbonate produced by the interface process. In order to recover some of the loss in resistance to hydrolysis, an epoxide compound is normally added. The combination of epoxide and phosphorus compounds, however, does not produce any better a resistance to hydrolysis by the polycarbonate than is achieved without adding these two substances. At best, addition of the epoxide may compensate for the impairment in resistance to hydrolysis caused by the phosphorus compound.

### DETAILED DESCRIPTION OF THE INVENTION

Surprisingly, it was found that the resistance to hydrolysis of a polycarbonate produced by melt polymerization (herein melt polycarbonate) is improved by adding phosphorus compounds. This effect occurs without the addition of hydrolysis stabilizers based on epoxide.

The invention thus provides polycarbonates, copolycarbonates and/or polycarbonate esters obtained by melt polymerization which contain an organic phosphorus compound. The invention also provides compositions which contain one or more of the previously mentioned polymers. Finally, the invention provides the use of organic phosphorus compounds to improve the resistance to hydrolysis of polycarbonates and polyestercarbonates produced by the melt polymerization process.

Organic phosphorus compounds suitable for use according to the invention include phosphines, phosphine oxides, phosphinites, phosphonites, phosphites, diphosphines, diphosphinites, diphosphonites, diphosphites, phosphinates, phosphonates, phosphates, diphosphinates, diphosphonates and diphosphate compounds as well as oligomeric derivatives of the previously mentioned phosphorus compounds.

Suitable phosphine (PR₃) and phosphine oxide (OPR₃) compounds according to the invention include those in which R is hydrogen, a C₁ to C₁₀₀ alkyl group or a non-substituted or substituted C₆ to C₁₄ aryl group. The groups R may be identical or different. The most preferred groups R are phenyl, 2-tert-butylphenyl, 2,4-di-tert-butylphenyl, 2,6-di-tert-butylphenyl, 2,4,6-tri-tert-butylphenyl, p-nonylphenyl and naphthylene. A particularly preferred phosphine is triphenyl phosphine.

Suitable phosphinite (P(OR)R₂), phosphonite (P(OR)₂R) and phosphite (P(OR)₃) compounds according to the invention are, for example, those in which R is hydrogen or a C₁ to C₁₀₀ alkyl group, or a non-substituted or substituted C₆ to C₁₄ aryl group. The groups R may be identical or different. The most preferred groups R are phenyl, 2-tert-butylphenyl, 2,4-di-tert-butylphenyl, 2,6-di-tert-butylphenyl, 2,4,6-tri-tert-butylphenyl, p-nonylphenyl and CH₃ to C₁₈H₃₇.

Suitable phosphinate (PO(OR)R₂), phosphonate (PO(OR)₂R) and phosphate (PO(OR)₃) compounds according to the invention include those in which R is hydrogen or a C₁ to C₁₀₀ alkyl group, or a non-substituted or substituted C₆ to C₁₄ aryl group. The groups R may be identical or different. The most preferred groups R are phenyl, 2-tert-butylphenyl, 2,4-di-tert-butylphenyl, 2,6-di-tert-butylphenyl, 2,4,6-tri-tert-butylphenyl, p-nonylphenyl and CH₃ to C₁₈H₃₇.

Suitable diphospine compounds R₂P-X-PR₂ according to the invention include those in which R is hydrogen or a C₁ to C₁₀₀ alkyl group, or a non-substituted or substituted C₆ to C₁₄ aryl group such as those which correspond to the formula (2) given below. The groups R may be identical or different. Further suitable compounds are those in which X is a divalent C₁ to C₁₀₀ alkyl group or a non-substituted or substituted C₆ to C₁₄ aryl group. Preferred divalent groups are phenylene, biphenylene, 2,2-diphenylpropane and naphthylene.

Suitable diphospinite ((RO)RP-X-PR(OR)), diphosphonite ((RO)₂P-X-P(OR)₂) and diphosphite ((RO)₂P-OXO-P(OR)₂) compounds according to the invention include those in which R is hydrogen or a C₁ to C₁₀₀ alkyl group, or a non-substituted or substituted C₆ to C₁₄ aryl group. The groups R may be identical or different. Further suitable compounds are those in which X is a divalent C₁ to C₁₀₀ alkyl group or a non-substituted or substituted C₆ to C₁₄ aryl group. Preferred divalent groups are phenylene, biphenylene and naphthylene.

In particular, X may be a group of the formula (2)

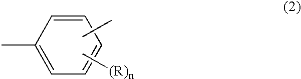

or of the formula (3)

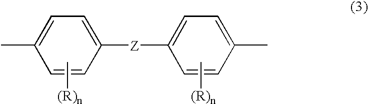

in which

R represents a substituted or unsubstituted phenyl, methyl, propyl, ethyl, butyl group, Cl or Br and n is 0, 1 or 2,

and Z represents a C₁ to C₈ alkylidene or C₅ to C₁₂ cycloakylidene group, S, SO₂ or a single bond.

Further diphosphites which are suitable according to the invention are those of the formula

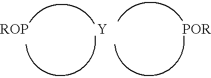

in which R is a C₁ to C₁₀₀ alkyl group, or a non-substituted or substituted C₆ to C₁₄ aryl group. Y is a tetravalent C₁ to C₁₀₀ alkoxy group. The most preferred tetravalent compound is pentaerythritol.

The most preferred phosphites are triphenyl phosphite, tris-(2-tert-butylphenyl) phosphite, tris-(2,4-di-tert-butylphenyl) phosphite, tris-(2,6-di-tert-butylphenyl) phosphite (Irganox 168®:

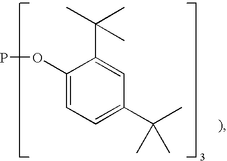

tris-(2,4,6-tri-tert-butylphenyl) phosphite, (2,4,6-tri-tert-butyl phenyl )-(2-butyl-2-ethyl-propan-1,3-diyl) phosphite (Utranox 641®:

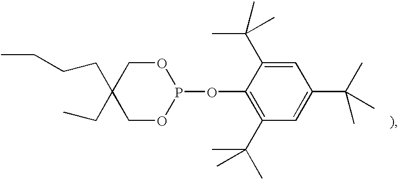

bis-(2,4-di-cumyl-phenyl)-pentaerythrityl diphosphite, bis-(2,4-di-tert-butylphenyl)-pentaerythrityl diphosphite, distearylpentaerythrityl diphosphite, tris-(p-nonylphenyl) phosphite, diphenylisodecyl phosphite, diisodecylphenyl phosphite, triisodecyl phosphite, trilauryl phosphite and tris-[(3-ethyloxyethanyl-3)-methyl] phosphite. The most preferred phosphine is triphenyl phosphine. The most preferred phosphonite is tetrakis-(2,4-di-tert-butylphenyl)[1,1-biphenyl]-4,4′-diyl biphosphonite.

The most preferred phosphates are tris-(2-ethylhexyl) phosphate, triphenyl phosphate, tris-(2-tert-butylphenyl) phosphate, tris-(2,4-di-tert-butylphenyl) phosphate, tris-(2,6-di-tert-butylphenyl) phosphate and tris-(2,4,6-tri-tert-butylphenyl) phosphate.

The phosphorus compounds are commercially available and may contain varying amounts of impurities. Only compounds of high purity and those with only negligible amounts of acid groups, amine compounds and residual salts such as alkali metal and alkaline earth metal salts are preferably used.

The phosphorus compounds may also be used in mixtures of more than one phosphorus compound, in order to optimize the properties of polycarbonate compositions. These phosphorus compounds are also commercially available as mixtures with further stabilizers and additives such as UV absorbers, mold release agents, glass, further polymers, hindered phenols and lactones.

The phosphorus compounds are used according to the invention as a component in a mixture with the polycarbonates/polyestercarbonates. The phosphorus compounds exhibit effects according to the invention in amounts of 10 ppm to 30%, with respect to the amount of melt polycarbonate. The phosphorus compounds are preferably used in amounts of 10 ppm to 1 wt. %, with respect to the weight of polycarbonate, in order to produce the desired effect according to the invention.

The phosphorus compound being added according to the invention may be added to the monomers or to the catalyst solution before melt polymerization. The phosphorus compound may also be added during the melt polymerization process or added directly to the molten stream at the end of melt polymerization. Finally, the phosphorus compound may be admixed with the polycarbonate/polyestercarbonate in a further step, for example during compounding.

The effect of phosphorus compounds according to the invention is displayed in melt polycarbonates of the general formula (1)

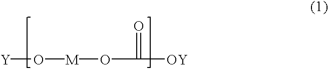

wherein the square brackets denote repeating structural units,

M may be Ar or a multifunctional group A, B, C or group D,

wherein Ar may be a group which is represented by the formula (2) (2)

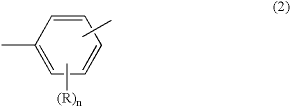

or particularly preferably by a group which is represented by the formula (3)

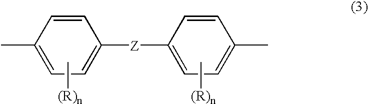

wherein

Z represents a C₁ to C₈ alkylidene or C₅ to C₁₂ cycloalkylidene group, S, SO₂ or a single bond,

R represents a substituted or unsubstituted phenyl, methyl, propyl, ethyl, butyl group, Cl or Br and n is 0, 1 or 2,

wherein the multifunctional group A is a group of the formula

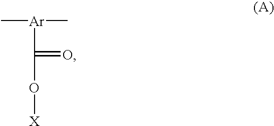

wherein the multifunctional group B is a group of the formula

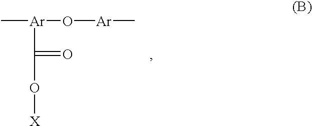

wherein the multifunctional group C is a group of the formula

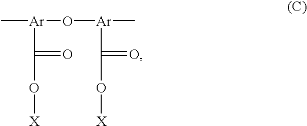

wherein group D is a group of the formula

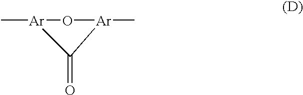

and the sum of multifunctional groups A, B, C and D is >5 ppm, wherein Y=H or a group of the formula (4) (4),

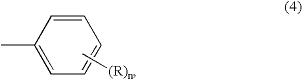

wherein

R identically or differently, represents H, C₁ to C₂₀ alkyl, C₆H₅ or C(CH₃)₂C₆H₅ and

n may be 0, 1, 2 or3,

wherein X=Y or —(MOCOO)Y,

wherein

M and Y are defined as above.

Particularly preferred are polycarbonates with a pseudoplastic characteristic (y) which is defined by the limiting values of the following equation

c+ax^{b}>y>−c+ax^{b} (Q)

for all y≧1,

wherein a, b and c are constants and

c=0.3 to 0.1, preferably 0.2 to 0.1 and in the most preferred way is about 0.1,

b=14.831±0.05 to 0.02, preferably ±0.04 to 0.02 and in the most preferred way ± about 0.02 and

a=0.1262±0.005 to 0.003, preferably ±0.004 to 0.003 and in the most preferred way ± about 0.003 and x is the relative viscosity of the polycarbonate.

The polycarbonate according to the invention may have a weight average molecular weight, determined by gel permeation chromatography, of 5,000 to 80,000, preferably 10,000 to 60,000 and in the most preferred way 15,000 to 40,000.

Ar is preferably defined as follows:

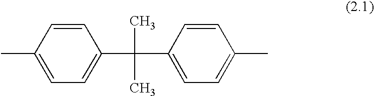

the multifunctional group A is preferably the group A1:

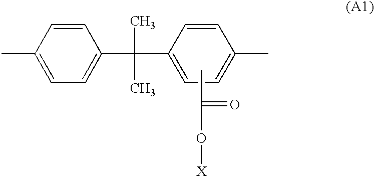

the group B is preferably the group B1:

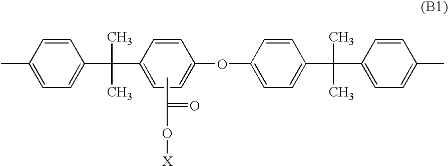

the multifunctional group C is preferably the group C1:

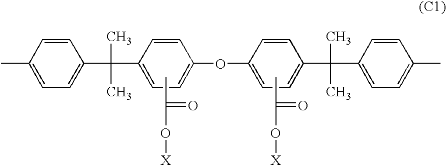

In groups B1 and C1, X is defined in the same way as above. Group D is preferably the group D1:

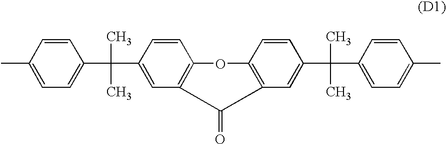

The previously mentioned melt polycarbonates are mentioned only by way of example. The proportions of components A to D may also be present in larger or smaller proportions in the melt polycarbonate.

The preparation of aromatic polycarbonates by the melt transesterification process is known and is described, for example, in “Schnell”, Chemistry and Physics of Polycarbonates, Polymer Reviews, vol. 9, Interscience Publishers, New York, Sydney 1964; reference is made to D. C. Prevorsek, B. T. Debona and Y. Kesten, Corporate Research Center, Allied Chemical Corporation, Moristown, N.J. 07960, “Synthesis of Poly(ester)carbonate Copolymers” in Journal of Polymer Science, Polymer Chemistry edition, vol.19, 75-90 (1980), to D. Freitag, U. Grigo, P. R. Muller, N. Nouvertne, Bayer AG, “Polycarbonates” in Encyclopedia of Polymere Science and Engineering, vol.11, second edition, 1988, pages 648-718 and finally to Des. U. Grigo, K. Kirchner and P. R. Müller “Polycarbonate” in Becker/Braun, Kunststoff-Handbuch, vol. 3/1, Polycarbonate, Polyacetale, Polyester, Celluloseester, Carl Hanser Verlag, Munich, Vienna 1992, Pages 117-299, all incorporated by reference herein.

The polycarbonate/polyestercarbonate to be used with a phosphorus compound according to the invention is prepared by the melt transesterification reaction of suitable diphenols and diaryl carbonates in the presence of a suitable catalyst. The polycarbonate may also be prepared by the condensation of carbonate oligomers which contain hydroxy or carbonate end groups and suitable diphenols and also diaryl carbonates.

Suitable diaryl carbonates in the context of the invention are di-C₆ to C₁₄ aryl esters, preferably the diesters of phenol or of alkyl-substituted phenols, i.e. diphenyl carbonate, dicresyl carbonate and di-4-tert-butylphenyl carbonate. Diphenyl carbonate is the most preferred.

Suitable carbonate oligomers are described by the formula (1) above and have molecular weights of 153 to 15,000.

Included among suitable di-C₆-C₁₄ aryl esters are also asymmetric diaryl esters, which contain a mixture of aryl substituents. Phenylcresyl carbonate and 4-tert-butylphenylphenyl carbonate are most preferred.

Included among suitable diaryl esters are also mixtures of more than one di-C₆-C₁₄ aryl ester. The most preferred mixtures are mixtures of diphenyl carbonate, dicresyl carbonate and di-4-tert-butylphenyl carbonate.

With respect to 1 mole of diphenol, the diaryl carbonates may be used in amounts of 1.00 to 1.30 moles, particularly preferably in amounts of 1.02 to 1.20 moles and most preferably in amounts of 1.05 to 1.15 moles.

Suitable dihydroxybenzene compounds in the context of the invention correspond to the formula (5):

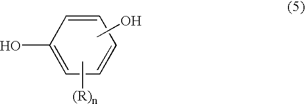

in which

R is a substituted or unsubstituted phenyl, methyl, propyl, ethyl, butyl group, Cl or Br and

n is 0, 1 or 2.

Most preferred dihydroxybenzene compounds are 1,3-dihydroxybenzene, 1,4-dihydroxybenzene and 1,2-dihydroxybenzene.

Suitable diphenols in the context of the invention correspond to the formula (6):

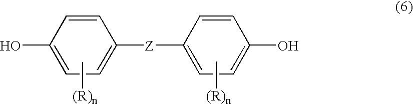

wherein

Z is a C₁ to C₈ alkylidene or C₅ to C₁₂ cycloalkylidene group, S, SO₂ or a single bond,

R is a substituted or unsubstituted phenyl, methyl, propyl, ethyl, butyl group, Cl or Br and

n is 0, 1 or 2.

Preferred diphenols are 4,4′-dihydroxydiphenyl, 4,4′-dihydroxy-diphenyl sulfide, 1,1-bis-(4-hydroxyphenyl)-cyclohexane, 1,2-bis-(4-hydroxyphenyl)-benezene, 1,3-bis-(4-hydroxyphenyl)-benzene, 1,4-bis-(4-hydroxyphenyl)-benezene, bis-(4-hydroxyphenyl)-methane, 2,2-bis-(4-hydroxyphenyl)-propane, 2,4-bis-(4-hydroxyphenyl)-2-methyl-butane, 2,2-bis-(3-methyl-4-hydroxyphenyl)-propane, 2,2-bis-(3-chloro-4-hydroxy-phenyl)-propane, bis-(3,5-dimethyl-4-hydroxyphenyl)-methane, 2,2-bis-(3,5-dimethyl-4-hydroxyphenyl)-propane, bis-(3,5-dimethyl-4-hydroxy-(phenyl)-sulfone, bis-(4-hydroxyphenyl)-sulfone, 1,2-bis-[2-(4-hydroxy-phenyl)-isopropyl]-benzene, 1,3-bis-[2-(4-hydroxyphenyl)-isopropyl]-benzene, 1,4-bis[2-(4-hydroxyphenyl)-isopropyl]-benzene, 1,1-bis-(4-hydroxyphenyl)-1-phenylethane, 2,4-bis-(4-hydroxyphenyl)-2-methyl-butane, 2,2-bis-(3,5-dichloro-4-hydroxyphenyl)-propane, 2,2-bis-(3,5-dibromo-4-hydroxyphenyl)-propane, 1,1-bis-(4-hydroxyphenyl)-3,3,5-trimethylcyclohexane.

The most preferred diphenols are 1,1-bis-(4-hydroxyphehyl)-1-phenylethane 2,2-bis-(4-hydroxyphenyl)-propane, 4,4′-dihydroxydiphenyl, 1,1 -bis-(4-hydroxyphenyl)-3,3,5-trimethylcyclohexane, 2,2-bis-(3,5-dibromo-4-hydroxyphenyl)-propane and 1,3-bis-[2-(4-hydroxyphenyl)-isopropyl]-benzene.

Included among suitable diphenols are also mixtures of more than one diphenol; a copolycarbonate would then result. The most preferred mixing partners are 1,3-bis-[2-(4-hydroxyphenyl)-isopropyl]-benzene, 1,1-bis-(4-hydroxyphenyl)-3,3,5-trimethyl-cyclohexane, 2,2-bis-(4-hydroxyphenyl)-propane, 4,4′-dihydoxydiphenyl and 2,2-bis-(3,5-dibromo-4-hydroxyphenyl)-propane.

In addition, a branching agent may be added such as e.g. compounds which contain three functional phenolic OH groups. Obviously this would produce branches in the polymer and would increase the non-Newtonion flow behaviour. Included among suitable branching agents are phloroglucine, 3,3-bis-(3-methyl-4-hydroxyphenyl)-2-oxo-2,3-dihydroindole, 4,6-dimethyl-2,4,6-tris-(4-hydroxyphenyl)-hept-2-ene, 4,6-dimethyl-2,4,6-tris-(4-hyd roxyphenyl)-heptane, 1,3,5-tris-(4-hydroxyphenyl-benzene, 1,1,1-tris-(4-hydroxyphenyl)-ethane, tris-(4-hydroxyphenyl)-phenylmethane, 2,2-bis-[4,4-bis-(4-hydroxyphenyl)-cyclohexyl]-propane, 2,4-bis-(4-hydroxyphenylisopropyl)-phenol, 2,6-bis-(2-hydroxy-5′-methyl benzyl )-4-methylphenol, 2-(4-hydroxyphenyl)-2-(2,4-dihydroxyphenyl)-propane, hexakis-(4-(4-hydroxyphenylisopropyl)-phenyl) orthoterephthalate, tetrakis-(4-hydroxyphenyl)-methane tetrakis-(4-(4-hydroxyphenyl-isopropyl)-phenoxy)-methane, 1,4-bis-((4′,4″-dihydroxy-triphenyl)-methyl)-benzene, and isatinbiscresol, pentaerythritol, 2,4-dihydoxybenzoic acid, trimesic acid, cyanuric acid.

Catalysts suitable for preparing polycarbonates according to the invention include those of the general formula (7)

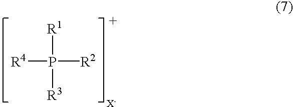

in which

R¹, R², R³ and R⁴, independently, may represent identical or different C₁ to C₁₈ alkylene, C₆ to C₁₀ aryl or C₅to C₆ cycloalkyl groups and

X⁻ may represent an anion where the corresponding acid-base pair H⁺+X⁻<−>HX has a pK_{b} of<11.

Preferred catalysts are tetraphenylphosphonium fluoride, tetraphenylphosphonium tetraphenylborate and tetraphenylphosphonium phenolate. The most preferred is tetraphenylphosphonium phenolate. Preferred amounts of phosphonium salt catalysts are, for example, 10⁻² to 10⁻⁸ mol per mol diphenol and the most preferred amounts of catalysts are 10⁻⁴ to 10⁻⁶ mol per mol diphenol. Further cocatalysts may optionally be used in addition to the phosphonium salt in order to increase the rate of polymerization. These include salts of alkali metals and alkaline earth metals such as hydroxides, alkoxides and aryloxides of lithium, sodium and potassium, preferably hydroxide, alkoxide or aryloxide salts of sodium. Sodium hydroxide and sodium phenolate are the most preferred. The amounts of cocatalysts may be, for example, in the range 1 to 200 ppb, preferably 5 to 150 ppb and most preferably 10 to 125 ppb, each being calculated as sodium.

The polycarbonates may be prepared under conditions where the reaction is performed in steps with temperatures of 150 to 400° C.; the residence time in each step may be 15 minutes to 5 hours and the pressures are 1000 to 0.01 mbar.

Compositions according to the invention may contain, apart from the polycarbonates or polyestercarbonates, further polymer constituents and conventional additives. Possible polymer constituents are, for example, styrene/acrylonitrile copolymers (SAN), acrylonitrile/butadiene/-styrene terpolymers (ABS), polymethylmethacrylate (PMMA), fluorinated polyolefins (PTFE), polyphenylenesulfide (PPS), polyolefins such as polyethylene, polypropylene and ethylene/propylene rubbers, epoxy resins, polyesters such as polybutylene terephthalate (PBT), polyethylene terephthalate (PET), polycyclohexenedimethanol (PCT), copolyesters of ethylene glycol and cyclohexenedimethanol terephthalic acid with the ratio of the two constituents being 1:4 (PCGT), copolyesters of ethylene glycol and cyclohexenedimethanol terephthalic acid with the ratio of the two constituents being 4:1 (PETG) and other polycarbonates produced by the interface process as well as mixtures of the previously mentioned components. Further additives are mold release agents, stabilizers, antioxidants, flame-proofing agents, colorants and pigments, antistatic agents, nucleating agents, anti-drip agents and organic and further inorganic fillers and reinforcing agents.

Polycarbonates according to the invention may be present in the composition according to the invention in an amount of preferably 5 to 95 wt. %, particularly preferably 10 to 90 wt. % and in the most preferred way 20 to 80 wt. %, with respect to the weight of the composition. The further polymer constituents in the composition according to the invention may be present in an amount of preferably 1 to 60 wt. %, particularly preferably I to 40 wt. % and in the most preferred way 2 to 30 wt. %, with respect to the weight of the composition.

The compositions may contain up to 60, preferably 10 to 40 wt. %, with respect to the filled or reinforced molding composition, of inorganic materials such as fillers and/or reinforcing agents. Flame-proofing agents may be present in compositions according to the invention in an amount of up to 35 wt. %, preferably 10 to 25 wt. %, with respect to the weight of the composition.

These and further constituents or additives possibly present in compositions according to the invention, apart from the polycarbonates/polyestercarbonates, are explained by way of example below.

These substances may be found in many publications such as, for example, in the Additives for Plastics Handbook, John Murphy, 1999 and are commercially available.

1. Suitable antioxidants are, for example:

1.1. Alkylated monophenols, for example 2,6-di-tert-butyl-4-methylphenol, 2-tert-butyl-4,6-dimethylphenol, 2,6-di-tert-butyl-4-ethylphenol, 2,6-di-tert-butyl-4-n-butylphenol, 2,6-di-tert-butyl-4-isobutylphenol, 2,6-dicyclopentyl-4-methylphenol, 2-(□-methyl-cyclohexyl)-4,6-dimethylphenol, 2,6-dioctadecyl-4-methylphenol, 2,4,6-tricyclo-hexylphenol, 2,6-di-tert-butyl-4-methoxymethylphenol, nonylphenols in which the side chain is linear or branched, for example 2,6-di-nonyl-4-methylphenol, 2,4-dimethyl-6-(1′-methylundec-1′-yl)-phenol, 2,4-dimethyl-6-(1′-methylheptadec-1′-yl)-phenol, 2,4-dimethyl-6-(1′-methyltridec-1′-yl)-phenol.

1.2. Alkylthiomethylphenols, for example 2,4-dioctylthiomethyl-6-tert-butylphenol, 2,4-dioctylthiomethyl-6-methylphenol, 2,4-dioctylthiomethyl-6-ethylphenol, 2,6-didodecylthiomethyl-4-nonylphenol.

1.3. Hydroquinones and alkylated hydroguinones, for example 2,6-di-tert-butyl-4-methoxyphenol, 2,5-di-tert-butylhydroquinone, 2,5-di-tert-amylhydroquinone, 2,6-diphenyl-4-octadecyloxyphenol, 2,6-di-tert-butylhydroquinone, 2,5-di-tert-butyl-4-hydroxyanisol, 3,5-di-tert-butyl-4-hydroxyanisol, 3,5-di-tert-butyl-4-hydroxyphenyl stearate, bis-(3,5-di-tert-butyl-4-hydroxyphenyl) adipate.

1.4. Tocopherols, for example α-tocopherol, βtocopherol, γ-tocopherol, δ-tocopherol and mixtures thereof (vitamin E).

1.5. Hydroxylated thiodiphenyl ethers, for example 2,2′-thio-bis-(6-tert-butyl-4-methylphenol), 2,2′-thio-bis-(4-octylphenol), 4,4′-thio-bis-(6-tert-butyl-3-methylphenol), 4,4′-thio-bis-(6-tert-butyl-2-methylphenol), 4,4′-thio-bis-(3,6-di-sec-amylphenol), 4,4′-bis-(2,6-dimethyl-4-hydroxyphenyl) disulfide.

1.6. Alkylidene bisphenols, for example 2,2′-methylene-bis-(6-tert-butyl-4-methyl-phenol), 2,2′-methylene-bis-(6-tert-butyl-4-ethylphenol), 2,2′-methylene-bis-[4-methyl-6-((α-methylcyclohexyl)-phenol], 2,2′-methylene-bis-(4-methyl-6-cyclohexylphenol), 2,2′-methylene-bis-(6-nonyl-4-methylphenol), 2,2′-methylene-bis-(4,6-di-tert-butyl-phenol), 2,2′-etylidene-bis-(4,6-di-tert-butylphenol), 2,2′-ethylidene-bis-(6-tert-butyl-4-isobutylephenol), 2,2′-methylene-bis-[6-(α-methylbenzyl)-4-nonylphenol], 2,2′-methylene-bis-[6-((α,α-dimethylbenzyl)-4-nonylphenol], 4,4′-methylene-bis-(2,6-di-tert-butylphenol), 4,4′-methylene-bis-(6-tert-butyl-2-methylphenol), 1,1 -bis-(5-tert-butyl-4-hydroxy-2-methylphenyl)butane, 2,6-bis-(3-tert-butyl-5-methyl-2-hydroxy-benzyl )-4-methylphenol, 1,1,3-tris-(5-tert-butyl-4-hydroxy-2-methylphenyl )-butane, 1,1-bis-(5-tert-butyl-4-hydroxy-2-methylphenyl)-3-n-dodecylmercaptobutane, ethyleneglycol bis-[3,3-bis-(3′-tert-butyl-4′-hydroxyphenyl)-butyrate], bis-(3-tert-butyl-4-hydroxy-5-methylphenyl)-dicyclopentadiene, bis-[2-(3′-tert-butyl-2′-hydroxy-5′-methylbenzyl)-6-tert-butyl-4-methylphenyl] terephthalate, 1,1-bis-(3,5-dimethyl-2-hydroxyphenyl)-butane, 2,2-bis-(3,5-di-tert-butyl-4-hydroxyphenyl)-propane, 2,2-bis-(5-tert-butyl-4-hydroxy-2-methylphenyl)-4-n-dodecylmercaptobutane, 1,1,5,5-tetra-(5-tert-butyl-4-hydroxy-2-methylphenyl)-pentane.

1.7. O-, N- and S-benzyl compounds, for example 3,5,3′, 5′-tetra-tert-butyl-4,4′-dihydroxydibenzyl ether, octadecyl-4-hyd roxy-3,5-dimethylbenzyl mercaptoacetate, tridecyl-4-hyd roxy-3,5-di-tert-butylbenzyl mercaptoacetate, tris-(3,5-di-tert-butyl-4-hydroxybenzyl)amine, bis-(4-tert-butyl-3-hydroxy-2,6-dimethylbenzyl)-dithio terephthalate, bis-(3,5-di-tert-butyl-4-hydroxybenzyl) sulfide, isooctyl-3,5-di-tert-butyl-4-hydroxybenzyl mercaptoacetate.

1.8. Hydroxybenzylated malonates, for example dioctadecyl-2,2-bis-(3,5-di-tert-butyl-2-hydroxybenzyl) malonate, dioctadecyl-2-(3-tert-butyl-4-hydroxy-5-methylbenzyl) malonate, didodecylmercaptoethyl-2,2-bis-(3,5-di-tert-butyl-4-hydroxybenzyl) malonate, bis-[4-(1,1,3,3-tetramethylbutyl)phenyl]-2,2-bis-(3,5-di-tert-butyl-4-hyd roxy-benzyl) malonate.

1.9. Aromatic hydroxvbenzyl compounds, for example 1,3,5-tris-(3,5-di-tert-butyl-4-hydroxybenzyl)-2,4,6-trimethyl benzene, 1,4-bis-(3,5-di-tert-butyl-4-hydroxybenzyl)-2,3,5,6-tetramethylbenzene, 2,4,6-tris-(3,5-di-tert-butyl-4-hydroxybenzyl)-phenol.

1.10. Triazine compounds, for example 2,4-bis-(octylmercapto)-6-(3,5-di-tert-butyl-4-hydroxyanilino)-1,3,5-triazine, 2-octylmercapto-4,6-bis-(3,5-di-tert-butyl-4-hydroxy-anilino)-1,3,5-triazine, 2-octylmercapto-4,6-bis-(3,5-di-tert-butyl-4-hydroxyphenoxy)-1,3,5-triazine, 2,4,6-tris-(3,5-di-tert-butyl-4-hydroxyphenoxy)-1,2,3-triazine, 1,3,5-tris-(3,5-di-tert-butyl-4-hydroxybenzyl) isocyanurate, 1,3,5-tris-(4-tert-butyl-3-hydroxy-2,6-dimethylbenzyl) isocyanurate, 2,4,6-tris-(3,5-di-tert-butyl-4-hydroxyphenylethyl)-1,3,5-triazine, 1,3,5-tris-(3,5-di-tert-butyl-4-hydroxyphenylpropionyl)-hexahydro-1,3,5-triazine, 1,3,5-tris-(3,5-dicyclohexyl-4-hydroxybenzyl) isocyanurate.

1.11. Acylaminophenols, for example 4-hydroxylauranilide, 4-hydroxystearanilide, octyl-N-(3,5-di-tert-butyl-4-hydroxyphenyl)-carbamate.

1.12. Esters of □-(3,5-di-tert-butyl-4-hydroxyphenyl) propionic acid with monohydric or polyhydric alcohols, e.g. with methanol, ethanol, n-octanol, i-octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris-(hydroxyethyl) isocyanurate, N,N′-bis-(hydroxyethyl)-oxamide, 3-thiaundecanol, 3-thiapentadecanol, trimethylhexanediol, trimethylolpropane, 4-hydroxymethyl-1-phospha-2,6,7-trioxabicyclo[2.2.2]octane.

1. 13. Esters of □-(5-tert-butyl-4-hydroxy-3-methylphenyl) propionic acid with monohydric or polyhydric alcohols, e.g. with methanol, ethanol, n-octanol, i-octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris-(hydroxyethyl) isocyanurate, N,N′-bis-(hydroxyethyl)-oxamide, 3-thiaundecanol, 3-thiapentadecanol, trimethylhexanediol, trimethylolpropane, 4-hydroxymethyl-1-phospha-2,6,7-trioxabicyclo[2.2.2]octane.

1.14. Esters of β-(3,5-dicyclohexyl-4-hydroxyphenyl) propionic acid with monohydric or polyhydric alcohols, e.g. with methanol, ethanol, octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris-(hydroxyethyl) isocyanurate, N,N′-bis-(hydroxyethyl)-oxamide, 3-thiaundecanol, 3-thiapentadecanol, trimethylhexanediol, trimethylolpropane, 4-hydroxymethyl-1-phospha-2,6,7-trioxabicyclo[2.2.2]octane.

1.15. Esters of 3,5-di-tert-butyl-4-hydroxyphenyl acetic acid with monohydric or polyhydric alcohols, e.g. methanol, ethanol, octanol, octadecanol, 1,6-hexanediol, 1,9-nonanediol, ethylene glycol, 1,2-propanediol, neopenty glycol, thiodiethylene glycol, diethylene glycol, triethylene glycol, pentaerythritol, tris-(hydroxyethyl) isocyanurate, N,N′-bis-(hydroxyethyl)-oxamide, 3-thiaundecanol, 3-thiapentadecanol, trimethyl-hexanediol, trimethylolpropane, 4-hydroxymethyl-1-phospha-2,6,7-trioxa-bicyclo[2.2.2]octane.

1.16. Amides of β-(3,5-di-tert-butyl-4-hydroxyphenyl) propionic acid, e.g. N,N′-bis-(3,5-di-tert-butyl-4-hydroxyphenylpropionyl)-hexamethylene diamide, N,N′-bis-(3,5-di-tert-butyl-4-hydroxyphenylpropionyl)-trimethylene diamide, N,N′-bis-(3,5-di-tert-butyl-4-hydroxyphenylpropionyl) hydrazide, N,N′-bis-[2-(3-[3,5-di-tert-butyl-4-hydroxy-phenyl]-propionyloxy)-ethyl] oxamide (Naugard® XL-1 from Uniroyal).

1.17. Ascorbic acid (vitamin C)

1.18. Amino antioxidants, e.g. N,N′-diisopropyl-p-phenylenediamine, N,N′-di-sec-butyl-p-phenylenediamine, N,N′-bis-(1,4-dimethylpentyl)-p-phenylenediamine, N,N′-bis-(1-ethyl-3-methylpentyl)-p-phenylenediamine, N,N′-bis-(1-methylheptyl)-p-phenylenediamine, N,N′-dicyclohexyl-p-phenylenediamine, N,N′-diphenyl-p-phenylenediamine, N,N′-bis-(2-naphthyl)-p-phenylenediamine, N-isopropyl-N′-phenyl-p-phenylenediamine, N-(1,3-dimethylbutyl)-N′-phenyl-p-phenylenediamine, N-(1-methyl-heptyl)-N′-phenyl-p-phenylenediamine, N-cyclohexyl-N′-phenyl-p-phenylenediamine, 4-(p-toluenesulfamoyl)-diphenylamine, N′N′-dimethyl-N,N′-di-sec-butyl-p-phenylenediamine, diphenylamine, N-allyidiphenylamine, 4-isopropoxydiphenylamine, N-phenyl-1-naphthylamine, N-(4-tert-octylphenyl)-1-naphthylamine, N-phenyl-2-naphthylamine, octylated diphenylamine, e.g. p,p′-di-tert-octyidiphenylamine, 4-n-butylaminophenol, 4-butyrylaminophenol, 4-nonanoyl-aminophenol, 4-dodecanoylaminophenol, 4-octadecanoylaminophenol, bis-(4-methoxyphenyl)-amine, 2,6-di-tert-butyl-4-dimethylaminomethylphenol, 2,4′-diaminodiphenylmethane, 4,4′-diaminodiphenylmethane, N,N,N′,N′-tetramethyl-4,4′-diaminodiphenylmethane, 1,2-bis-[(2-methylphenyl)-amino]-ethane, 1,2-bis-(phenylamino)-propane, (o-toluyl)-biguanide, bis-[4-(1′,3′-dimethylbutyl)-phenyl]-amine, tert-octylated N-phenyl-1-naphthylamine, a mixture of mono- and dialkylated tert-butyl/tert-octyldiphenylamines, a mixture of mono- and dialkylated nonyldiphenylamines, a mixture of mono- and dialkylated dodecyldiphenylamines, a mixture of mono- and dialkylatedisopropyl/isohexyldiphenylamines, a mixture of mono- and dialkylated tert-butyidiphenylamines, 2,3-dihydro-3,3-dimethyl-4H-1,4-benzothiazine, phenothiazine, a mixture of mono- and dialkylated tert-butyl/tert-octylphenothiazines, a mixture of mono- and dialkylafed tert-octylphenothiazines, N-allylphenothiazine, N,N,N′,N′-tetraphenyl-1,4-diaminobut-2-ene, N,N-bis-(2,2,6,6-tetramethylpiperid-4-yl)-hexamthylenediamine, bis-(2,2,6,6-tetrapiperid-4-yl) sebacate, 2,2,6,6-tetramethylpiperidin-4-one, 2,2,6,6-tetramethylpiperidin-4-ol. These compounds may be usedindividually or as mixtures.

1.19. Suitable thiosynergistic compounds are for example dilauryl thiodipropionate and/or distearyl thiodipropionate.

2. UV-absorbers and light stabilizers may be usedin compositions according to the invention in amounts of 0.1 to 15 wt. %, preferably 3 to 8 wt. %, with respect to the weight of the composition. Suitable UV absorbers and light stabilizers are for example:

2.1. 2-(2′-hydroxvphenyl)-benzotriazoles, for example 2-(2′-hydroxy-5′-methylphenyl)-benzotriazole, 2-(3′,5′-di-tert-butyl-2′-hydroxyphenyl)-benzotriazole, 2-(5′-tert-butyl-2′-hydroxyphenyl)-benzotriazole, 2-(2′-hydroxy-5′-(1,1,3,3-tetramethylbutyl)-phenyl)-benzotriazole, 2-(3′,5′-di-tert-butyl-2′-hydroxyphenyl)-5-chlorobenzotriazole, 2-(3′-tert-butyl-2′-hydroxy-5′-methylphenyl)-5-chlorobenzotriazole, 2-(3′-sec-butyl-5′-tert-butyl-2′-hydroxyphenyl)benzotriazole, 2-(2′-hydroxy-4′-octyloxyphenyl)-benzotriazole, 2-(3′,5′-di-tert-amyl-2′-hydroxyphenyl) benzotriazole, 2-(3′,5′-bis-(α,α-dimethylbenzyl)-2′-hydroxyphenyl)-benzotriazole, 2-(3′-tert-butyl-2′-hydroxy-5′-(2-octyloxycarbonylethyl)-phenyl)-5-chlorobenzo-triazole, 2-(3′-tert-butyl-5′-[2-(2-ethylhexyloxy)-carbonylethyl]-2′-hydroxyphenyl)-5-chlorobenzo-triazole, 2-(3′-tert-butyl-2′-hydroxy-5′-(2-methoxycarbonylethyl)-phenyl)5-chloro-benzotriazole, 2-(3′-tert-butyl-2′-hydroxy-5′-(2-methoxycarbonylethyl)-phenyl )-benzotriazo, 2-(3′-tert-butyl-2′-hydroxy-5′-(2-octyloxycarbonylethyl)-phenyl)-benzotriazole, 2-(3′-tert-butyl-5′-[2-(2-ethylhexyloxy)-carbonylethyl]-2′-hydroxyphenyl)-benzotriazole, 2-(3′-dodecyl-2′-hydroxy-5′-methylphenyl)-benzotriazole, 2-(3′-tert-butyl-2′-hydroxy-5′-[2-isooctyloxycarbonylethyl)-phenylbenzo-triazole, 2,2′-methylene-bis-[4-( 1,1,3,3-tetramethyl butyl)-6-beniotriazol-2-ylphenol]; the transesterification product of 2-[3′-tert-butyl-5′-(2-methoxycarbonylethyl)-2′-hydroxyphenyl]-2 H-benzotriazole and polyethylene glycol 300; [R—CH₂CH₂—COO—CH₂CH₂]₂, wherein R=3′-tert-butyl-4′-hydroxy-5′-2H-benzotriazol-2-ylphenyl, 2-[2′-hyd roxy-3′-(α,α-dimethylbenzyl)-5′-(1,1,3,3-tetrametylbutyl)-phenyl]-benzotriazole, 2-[2′-hydroxy-3′-(1,1,3,3-tetramethylbutyl)-5′-(α,α-dimethylbenzyl)-phenyl]-benzotriazole.

2.2. 2-hydroxvbenzophenones, for example the 4-hydroxy-, 4-methoxy-, 4-octyloxy-, 4-decyloxy-, 4-dodecyloxy-, 4-benzyloxy-, 4,2′,4′-trihydroxy- and 2′-hydroxy-4,4′-dimethoxy- derivatives.

2.3. Esters of substituted and unsubstituted benzoic acid such as for example 4-tert-butylphenyl salicylate, phenyl salicylate, octylphenyl salicylate, bibenzoylresorcinol, bis-(4-tert-butylbenzoyl)-resorcinol, benzoylresorcinol, 2,4-di-tert-butylphenyl-3,5-di-tert-butyl 4-hydroxybenzoate, hexadecyl-3,5-di-tert-butyl 4-hydroxybenzoate, octadecyl-3,5-di-tert-butyl 4-hydroxybenzoate, 2-methyl-4,6-di-tert-butylphenyl-3,5-di-tert-butyl 4-hyd roxybenzoate.

2.4. Acrvlates, for example ethyl-α-cyano-β,β-diphenyl acrylate, isooctyl-α-cyano-β,β-diphenyl acrylate, methyl-β-carbomethoxy cinnamate, methyl-α-cyano-βmethyl-p-methoxy cinnamate, butyl-(α-cyano-β-methyl-p-methoxy cinnamate, methyl-p-carbomethoxy-p-methoxy cinnamate and N-(β-carbomethoxy-β-cyanovinyl)-2-methyl-indoline.

2.5. Nickel compounds, for example nickel complexes of 2,2′-thiobis-[4-(1,1,3,3-tetramethylbutyl)-phenol] such as the 1:1 or 1:2 complex, with or without additional ligands such as n-butylamine, triethanolamine or N-cyclohexyldiethanolamine, nickel dibutyidithiocarbamate, nickel salts of monoalkylesters, e.g. of the methyl or ethyl esters, of 4-hydroxy-3,5-di-tert-butylbenzylphosphonic acid, nickel complexes of ketoximes, e.g. of 2-hydroxy-4-methylphenylundecylketoxime, nickel complexes of 1-phenyl-4-lauroyl-5-hydroxypyrazole, with or without additional ligands.

2.6. Sterically hindered amines, for example bis-(2,2,6,6-tetramethyl-4-piperidyl) sebacate, bis-(2,2,6,6-tetramethyl-4-piperidyl) succinate, bis-(1,2,2,6,6-pentamethyl-4-piperidyl) sebacate, bis-(1-octyloxy-2,2,6,6-tetramethyl-4-piperidyl) sebacate, bis-(1,2,2,6,6-pentamethyl-4-piperidyl), n-butyl-3,5-di-tert-butyl-4-hydroxy-benzyl malonate, the condensate of 1-(2-hyd roxyethyl )-2,2,6,6-tetramethyl-4-hyd roxypiperidine and succinic acid, linear or cyclic condensates of N,N′-bis-(2,2,6,6-tetramethyl-4-piperidyl)-hexamethylenediamine and 4-tert-octylamino-2,6-di-chloro-1,3,5-triazine, tris-(2,2,6,6-tetramethyl-4-piperidyl )-nitrilotriacetate, tetrakis-(2,2,6,6-tetramethyl-4-piperidyl)-1,2,3,4-butane tetracarboxylate, 1,1′-(1,2-ethanediyl)-bis-(3,3,5,5-tetramethylpiperazinone), 4-benzoyl-(2,2,6,6-tetramethylpiperidine, 4-stearyloxy-2,2,6,6-tetramethylpiperidine, bis-(1,2,2,6,6-pentamethylpiperidyl)-2-n-butyl-2-(2-hydroxy-3,5-di-tert-butylbenzyl) malonate, 3-n-octyl-7,7,9,9-tetramethyl-1,3,8-triaza-spiro[4.5]decane-2,4-dione, bis-(1-octyloxy-2,2,6,6-tetramethylpiperidyl) sebacate, bis-(1-octyloxy-2,2,6,6-tetramethylpiperidyl) succinate, linear or cyclic condensates of N,N′-bis-(2,2,6,6-tetramethyl-4-piperidyl)-hexamethylenediamine and 4-morpholino-2,6-dichloro-1,3,5-triazine, the condensate of 2-chloro-4,6-bis-(4-n-butylamino-2,2,6,6-tetramethyl-piperidyl)-1,3,5,-triazine, and 1,2-bis-(3-aminopropylamino)-ethane, the condensate of 2-chloro-4,6-bis-(4-n-butylamino-1,2,2,6,6-pentamethyl-piperidyl)-1,3,5,-triazine and 1,2-bis-(3-aminopropylamino)-ethane, 8-acetyl-3-dodecyl-7,7,9,9-tetramethyl-1,3,8-triazaspiro[4.5]-decane-2,4-dione, 3-dodecyl-1-(2,2,6,6-tetramethyl-4-piperidyl)-pyrrolidine-2,5-dione 3-dodecyl-1-(1,2,2,6,6-pentamethyl-4-piperidyl)-pyrrolidine-2,5-dione, a mixture of 4-hexadecyloxy- and 4-stearyloxy-2,2,6,6-tetramethylpiperidine, a condensation product of N,N′-bis-(2,2,6,6-tetramethyl-4-piperidyl)-hexamethylenediamine and 4-cyclohexylamino-2,6-dichloro-1,3,5-triazine, a condensation product of 1,2-bis-(3-aminopropylamino)-ethane and 2,4,6,-trichloro-1,3,5-triazine and also 4-butylamino-2,2,6,6-tetramethyl-piperidine (CAS Reg. No. [136504-96-6]; N-(2,2,6,6-tetramethyl-4-piperidyl)-n-dodecysuccinimide, N-(1,2,2,6,6-pentamethyl-4-piperidyl)-n-dodecylsuccinimide, 2-undecyl-7,7,9,9-tetramethyl-1-oxa-3,8-diaza-4-oxospiro[4.5]decane, a reaction product of 7,7,9,9-tetramethyl-2-cycloundecyl-1 -oxa-3,8-diaza-4-oxospiro[4.5]decane and epichlorhydrin, 1,1-bis-(1,2,2,6,6-pentamethyl-4-piperidyloxycarbonyl)-2-(4-methoxyphenyl)-ethene, N,N′-bis-(formyl)-N,N′-bis-(2,2,6,6-tetramethyl-4-piperidyl)-hexamethylenediamine, diesters of 4-methoxymethylene malonic acid with 1,2,2,6,6-pentamethyl-4-hydroxypiperidine, poly[methylpropyl-3-oxy-4-(2,2,6,6-tetramethyl-4-piperidyl)-siloxane, the reaction product of a maleic anhydride/α-olefine copolymer with 2,2,6,6-tetramethyl-4-aminopiperidine or 1,2,2,6,6-pentamethyl-4-aminopiperidine.

2.7. Oxamides, for example 4,4′-dioctyloxyoxanilide, 2,2′-diethoxyoxanilide, 2,2′-dioctyloxy-5,5′-di-tert-butoxanilide, 2,2′-didodecyolxy-5,5′-di-tert-butoxanilide, 2-ethoxy-2′-ethyloxanilide, N, N′-bis-(3-dimethylaminopropyl)-oxamide, 2-ethoxy-5-tert-butyl-2′-ethoxanilide and its mixture with 2-ethoxy-2′-ethyl-5,4′-di-tert-butoxanilide, mixtures of o- and p-methoxy disubstituted oxanilides and mixtures of o- and p-ethoxy disubstituted oxanilides.

2.8. 2-(2-hydroxvphenyl)-1,3,5-triazines, for example 2,4,6-tris-(2-hydroxy-4-octyl-oxyphenyl)-1,3,5-triazine, 2-(2-hydroxy-4-octyloxyphenyl)-4,6-bis(2,4-dimethylphenyl)-1,3,5-triazine, 2-(2,4-dihydroxyphenyl)-4,6-bis-(2,4-dimethylphenyl)-1,3,5-triazine, 2,4-bis-(2-hydroxy-4-propyloxyphenyl)-6-(2,4-dimethylphenyl)-1,3,5-triazine, 2-(2-hydroxy-4-octyloxyphenyl)-4,6-bis-(4-methylphenyl)-1,3,5-triazine, 2-(2-hydroxy-4-dodecyloxyphenyl)-4,6-bis-(2,4-dimethylphenyl)-1,3,5-triazine, 2-(2-hydroxy-4-tridecyloxyphenyl)-4,6-bis-(2,4-dimethylphenyl)-1,3,5-triazine, 2-[2-hydroxy-4-(2-hydroxy-3-butyloxypropoxy)-phenyl]-4,6-bis-(2,4-dimethyl)-1,3,5-triazine, 2-[2-hydroxy-4-(2-hydroxy-3-octyloxypropyloxy)-phenyl]-4,6-bis-(2,4-dimethyl)-1,3,5-triazine, 2-[4-(dodecyloxy/tridecyloxy-2-hydroxypropoxy)-2-hydroxyphenyl]-4,6-bis-(2,4-dimethylphenyl)-1,3,5-triazine, 2-[2-hydroxy-4-(2-hydroxy-3-dodecyloxypropoxy)-phenyl]-4,6-bis-(2,4-dimethylphenyl)-1,3,5-triazine, 2-(2-hydroxy-4-hexyloxy)-phenyl-4,6-diphenyl)-1,3,5-triazine, 2-(2-hydroxy-4-methoxyphenyl)-4,6-diphenyl)-1,3,5-triazine, 2,4,6-tris-[2-hydroxy-4-(3-butoxy-2-hydroxypropoxy)-phenyl]- 1,3,5-triazine, 2-(2-hydroxyphenyl)-4-(4-methoxyphenyl)-6-phenyl-1,3,5-triazine, 2-{2-hydroxy-4-[3-(2-ethylyhexyl- 1 -oxy)-2-hyd roxypropyloxy]-phenyl}-4,6-bis-(2,4-dimethylphenyl)-1,3,5-triazine.

These compounds may be usedindividually or as a mixture.

3. Suitable metal deactivators are, for example, N,N′-diphenyloxamide, N-salicylal-N′-salicyloyl hydrazine, N,N′-bis-(salicyloyl) hydrazine, N,N′-bis-(3,5-di-tert-butyl-4-hydroxyphenylpropionyl) hydrazine, 3-salicyloylamino-1,2,4-triazole, bis-(benzylidene)-oxalyl dihydrazide, oxanilide, isophthaloyl dihydrazide, sebacoylbisphenyl hydrazide, N,N′-diacetyladipoyl dihydrazide, N,N′-bis-(salicyloyl)-oxalyl dihydrazide, N,N′-bis-(salicyloyl)-thiopropionyl dihydrazide. These compounds may be usedindividually or as a mixture.

5. Suitable peroxide traps are, for example esters of β-thiodipropionic acid, for example the lauryl, stearyl, myristyl, or tridecyl esters, mercaptobenzimidazole or the zinc salt of 2-mercaptobenzimidazole, zinc dibutyldithiocarbamate, dioctadecyidisulfide, pentaerythrityl tetrakis-(dodecylmercapto)-propionate. These compounds may be used individually or as a mixture.

6. Suitable basic costabilizers are, for example melamine, polyvinylpyrrolidone, dicyanodiamide, triallylcyanurate, urea derivatives, hydrazine derivatives, amines, polyamides, polyurethanes, alkali metal salts, and alkaline earth metal salts of higher fatty acids, for example calcium stearate, zinc stearate, magnesium behenate, magnesium stearate, sodium ricinoleate and potassium palmitate, antimony pyrocatecholate or zinc pyrocatecholate. These compounds may be used individually or as a mixture.

7. Suitable nucleating agents are, for example inorganic substances such as talc, metal oxides, such as titanium dioxide or magnesium oxide, phosphates, carbonates or sulfates, preferably of alkaline earth metals; organic compounds such as mono- or polycarboxylic acids and their salts, e.g. 4-tert-butylbenzoic acid, adipic acid, diphenylacetic acid, sodium succinate or sodium benzoate; polymeric compounds such as ionic copolymers (ionomers). 1,3:2,4-bis-(3′,4′-dimethylbenzylidene)-sorbitol, 1,3:2,4-di(paramethyldibenzylidene)-sorbitol and 1,3:2,4-di(benzylidene)-sorbitol are particularly preferred. These compounds may be used individually or as a mixture.

8. Suitable fillers and reinforcing agents are, for example calcium carbonate, silicates, glass fibers, glass beads, asbestos, talc, kaolin, mica, barium sulfate, metal oxides and hydroxides, carbon black, graphite, wollastonite, and wood flour or fibers of other natural products, synthetic fibers. These compounds may be usedindividually or as a mixture.

9. Suitable other additives are, for example plasticizers, lubricants, emulsifiers. pigments, viscosity modifiers, catalysts, flow control agents, optical brighteners, flame-proofing agents, antistatic agents and blowing agents.

10. Suitable benzofuranones andindolinones are, for example those which are disclosedin U.S. Pat. No. 4,325,863; U.S. Pat No. 4,338,244; U.S. Pat No. 5,175,052; U.S. Pat. No. 5,216,052 U.S. Pat. No. 5,252,643; DE-A-43 16 611; DE-A-43 16 62 876; EP-A-0 589 839 or EP-A-0 591 102, or 3-[4-(2-acetoxyethoxy)-phenyl]-5,7-di-tert-butyl-benzofuran-2-one, 5,7-di-tert-butyl-3-[4-(2-stearoyloxyethoxy)-phenyl]-benzofuran-2-one, 3,3′-bis-[5,7-di-tert-butyl-3-(4-[2-hydroxyethoxy]-phenyl)-benzofuran-2-one], 5,7-di-tert-butyl-3-[4-ethoxyphenyl)-benzofuran-2-one, 3-(4-acetoxy-3,5-dimethylphenyl)-5,7-di-tert-butylbenzofuran-2-one, 3-(3,5-dimethyl-4-pivaloyloxyphenyl)-5,7-di-tert-butylbenzofuran-2-one, 3-(3,4-dimethylphenyl)-5,7-di-tert-butyl-benzofuran-2-one, 3-(2,3-dimethylphenyl)- 5,7-di-tert-butylbenzofuran-2-one, lactone antioxidants such as

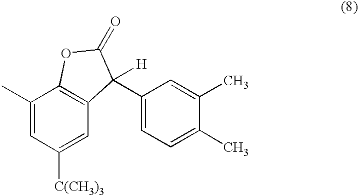

These compounds act, for example, as antioxidants. These compounds may be usedindividually or as a mixture.

11. Suitable fluorescent plasticizers are those listedin “Plastics Additives Handbook”, Eds. R. Gaächter and H. Müller, Hanser Verlag, 3rd edition, 1990, pages 775-789.

12. Suitable mold release agents are esters of aliphatic acids and alcohols, e.g. pentaerythrityl tetrastearate and glycerine monostearate.

They are usedindividually or in a mixture, preferably in an amount of 0.02 to 1 wt. % with respect to the weight of the composition.

13. Suitable flame-proofing additives are phosphate esters, i.e. 25 triphenylphosphates, resorcinyl diphosphates, bromine-containing compounds such as brominated phosphates, brominated oligocarbonates and polycarbonates, as well as salts such as C₄F₉SO₃⁻Na⁺.

14. Suitable impact modifiers are butadiene rubbers with grafted styrene/acrylonitrile or methylmethacrylate, ethylene/propylene rubbers with grafted maleic anhydride, ethyl- and butylacrylate rubbers with grafted methylmethacrylate or styrene/acrylonitrile, interpenetrating siloxane and acrylate networks with grafted methylmethacrylate or styrene/acrylonitrile.

15. Suitable polymers are SAN, ABS, PMMA, PTFE, PSU, PPS, polyolefins, such as polyethylene, polypropylene and ethylene/propylene rubbers, epoxy resins, polyesters, such as PBT, PET, PCT, PCTG and PETG and other polycarbonates producedin the interface process.

16. Suitable antistatic agents are sulfonate salts, for example tetraethylammonium salts of C₁₂H₂₅SO³⁻ or C₈F₁₇SO³⁻.

17. Suitable colorants are pigments and organic and inorganic dyes.

18. Compounds which contain epoxy groups such as 3,4-expoxycyclohexylmethyl-3,4-epoxycyclohexyl carboxylate, copolymers of glycidylmethacrylates and epoxysilanes.

19. Compounds which contain anhydride groups such as maleic anhydride, succinic anhydride, benzoic anhydride and phthalic anhydride.

The compounds in groups 18 and 19 act as melt stabilizers. They may be usedindividually or in mixtures.

Compositions according to the invention (molding compositions) are prepared by blending the relevant constituents in a known manner and melt compounding and melt extruding at temperatures of about 300° C. and for example at temperatures of 200° C. to 400° C. in conventional equipment such as internal compounders, extruders and twin-shaft screws. Blending the individual constituents may take place either in sequence or simultaneously, in fact either at about 20° C. (room temperature) or at elevated temperature.

Molding compositions according to the invention may be used to produce molded items of any type. These may be produced by injection molding, extrusion and blow molding techniques. Another form of processing is the production of molded items by thermoforming using previously prepared sheets or films.

Examples of molded items according to the invention are profiles, films, housing parts of any type, e.g. for domestic appliances such as juice presses, coffee machines, mixers; for office machines such as monitors, printers, copiers; for sheets, tubes, electrical installation ducts, windows, doors and profiles for the building sector, internal fittings and external applications; in the field of electrical engineering e.g. for switches and plugs. Furthermore, molded items according to the invention may be used for internal and structural parts for track vehicles, ships, aircraft, busses and other vehicles and also for body work parts for private cars.

Molded items according to the invention may be transparent or opaque. Further molded items are in particular optical and magneto optical data stores such as mini disks, compact disks (CDs) or digital versatile disks (DVDs), packaging for foodstuffs and drinks, optical lenses and prisms, lenses for illumination purposes, car headlamp lenses, glazing for buildings and vehicles, glazing of a different type such as for greenhouses, so-called twin wall sheets or hollow cavity sheets.

The following examples are used to explain the invention in more detail.

### EXAMPLES

Polycarbonate compositions based on two melt polycarbonates and a linear polycarbonate obtained by the interface process were prepared. Seven phosphorus compounds being usedin accordance with the invention were extrusion compounded with the polycarbonates using a ZSK33 twin screw extruder. This means that direct comparison of the effects of adding the phosphorus compound to the different polycarbonates was possible.

The resistance to hydrolysis was determined by placing the polycarbonate composition in a Zwick Melt Indexer at 300° C. in accordance with ASTM method D1238. The extruded granular compositions were first conditioned in air to give a water content of 0.12% and then the melt flow index test was performed. The molecular weight of the extruded composition and the molecular weight of the composition after the stability test were determined by correlation with measurements of the relative viscosity. The reduction in molecular weight was calculated by difference. The relative viscosity was measured at 20° C. in a 0.5% solution in methylene chloride.

The yellowness index was determined for injection molded samples with a thickness of 4 mm using the CIELAB method.

The amount of water in the polycarbonate was determined by the Karl-Fischer titration method.

TABLE 1

| Example | | 1 | 2 | 3 | 4 | 5 | 6 | 7 | 8 |
|---|---|---|---|---|---|---|---|---|---|
| PC1 | % | 100.00 | 99.7 | 99.99 | 99.9 | | | | |
| PC2 | % | | | | | 100.00 | 99.97 | 99.99 | 99.9 |
| Phosphorus compound 1 | % | | 0.03 | | | | 0.03 | | |
| Phosphorus compound 2 | % | | | 0.01 | | | | 0.01 | |
| Phosphorus compound 3 | % | | | | 0.1 | | | | 0.1 |
| M_{w} | | 28,949 | 28,561 | 28,432 | 28,561 | 28,820 | 28,561 | 28,561 | 28,562 |
| M_{w} after resistance to hydrolysis | | 25,584 | 25,713 | 27,525 | 26,619 | 28,043 | 23,360 | 26,888 | 26,360 |
| test with 0.12% moisture content | | | | | | | | | |
| Reduction in M_{w} | | 3,366 | 2,848 | 906 | 1,912 | 777 | 2,201 | 1,637 | 2,201 |
| YI | | 3.5 | 2.7 | 2.6 | 3.5 | 3.5 | 2.6 | 1.7 | 3.5 |

Notes relating to table 1:
PC1 is a bisphenol-A polycarbonate prepared by melt polymerization using 256 ppm compound A, 21 ppm compound B, 59 ppm compound C and 175 ppm compound D.
PC2 is a bisphenol-A polycarbonate prepared by the interface method with <5 ppm of compounds A, B, C and D.
Phosphorus compound 1 is tris-[(3-ethoxyetanyl-3)-methyl] phosphite
Phosphorus compound 2 is tris-(2-ethylhexyl) phosphate
Phosphorus compound 3 is triphenylphosphine
Table 2 gives further examples of various phosphorus compounds with the phosphorus in different oxidation states

TABLE 2

| Example | | 9 | 10 | 11 | 14 | 15 | 16 | 17 |
|---|---|---|---|---|---|---|---|---|
| PC3 | % | 100.00 | 99.95 | 99.95 | 99.95 | 99.95 | 99.95 | 99.95 |
| Phosphorus compound 4 | % | | 0.05 | | | | | |
| Phosphorus compound 1 | % | | | 0.05 | | | | |
| Phosphorus compound 5 | % | | | | 0.05 | | | |
| Phosphorus compound 6 | % | | | | | 0.05 | | |
| Phosphorus compound 7 | % | | | | | | 0.05 | |
| Phosphorus compound mixture | % | | | | | | | 0.05 |
| 8 | | | | | | | | |
| M_{w} | | 27,266 | 27,914 | 27,266 | 28,043 | 27,914 | 28,043 | 28,043 |
| M_{w} after resistance to hydrolysis | | 25,066 | 27,266 | 25,584 | 27,137 | 25,842 | 26,878 | 26,490 |
| test with 0.12% moisture content | | | | | | | | |
| Reduction in M_{w} | | 2,201 | 647 | 1,683 | 906 | 2,071 | 1,165 | 1,554 |
| Yl | | 4.3 | 4.2 | 3.6 | 3.3 | 3.2 | 3.3 | 3.0 |

SEITE
Notes relating to table 2:
PC3 is a bisphenol-A polycarbonate prepared by melt polymerization using 231 ppm compound A, 10 ppm compound B, 53 ppm compound C and 144 ppm compound D.
Phosphorus compound 4 is tris-(2,4-di-tert-butylphenyl) phosphite
Phosphorus compound 5 is 2,4,6-tri-tert-butylphenyl-3-butyl-2-ethyl-1,3-propanediol phosphite
Phosphorus compound 6 is bis-(2,4-dicumylphenyl)-pentaerythrityl diphosphite
Phosphorus compound 7 is tetrakis-(2,4-di-tert-butylphenyl)[1,1-biphenyl]-4,4′-diyl biphosphonite
Phosphorus compound mixture 8 is 57% tris-(2,4-di-tert-butylphenyl) phosphite, 28% octadecyl-3-(3,5-di-tert-butyl-4-hydroxyphenyl) propionate and 15% of the compound represented by formula (8).

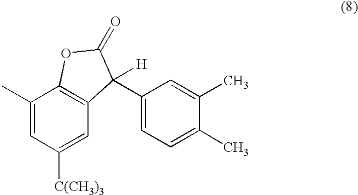

The results show that the loss in molecular weight due to the addition of phosphorus compounds to the melt compounded polymer is reduced. This is the opposite effect from that normally observed with polycarbonates produced by the interface method. It is therefore assumed that the resistance to hydrolysis of the melt polymerised polycarbonated is improved by the addition of a phosphorus compound, whereas the resistance to hydrolysis of the polycarbonate produced by the interface process is reduced.

Although the invention has been described in detail in the foregoing for the purpose of illustration, it is to be understood that such detail is solely for that purpose and that variations may be made therein by those skilled in the art without departing from the spirit and scope of the invention except as it may be limited by the claims.

What is claimed is:

1. A composition containing a melt polycarbonate conforming to formula (1) 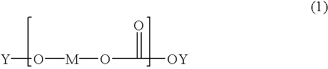
wherein the square brackets denote repeating structural units,
M denotes Ar or a multifunctional group A, B, C or group D,
wherein Ar is represented by the formula (2) 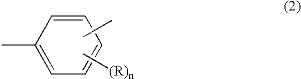
or formula (3) 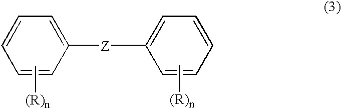
wherein
Z represents a C₁ to C₈ alkylidene or C₅ to C₁₂ cycloalkylidene group, S, SO₂ or a single bond,
R represents a substituted or unsubstituted phenyl, methyl, propyl, ethyl, butyl group, Cl or Br and n is 0, 1 or 2,
wherein group A conforms to 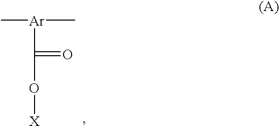
and group B confirms to 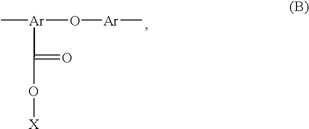
and group C conforms to 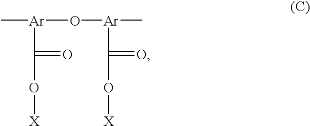
and group D conforms to 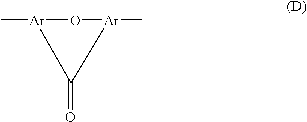
and the total amount of groups A, B, C and D is >5 ppm,
and wherein Y denotes H or a group of formula (4) 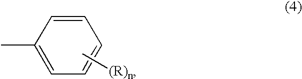
wherein
R identically or differently, represents H, C₁ to C₂₀ alkyl, C₆H₅ or C(CH₃)₂C₆H₅ and
n is0, 1, 2or3,
and wherein X is Y or —(MOCOO)Y, and a phosphorus-containing organic compound.

2. The composition according to claim 1, in which the phosphorus-containing organic compound is a member selected from the group consisting of phosphine (PR₃), phosphine oxide (OPR₃), phosphinite (P(OR)R₂), phosphonite (P(OR)₂R), phosphite (P(OR)₃), phosphinate (PO(OR)R₂), phosphonate (PO(OR)₂R) and phosphate (PO(OR)₃) , wherein R, all occurrences and independently is hydrogen, C₁ to C₁₀₀ alkyl group or C₆ to C₁₄ aryl group.

3. The composition according to claim 1 in which the phosphorus-containing organic compound is a member selected from the group consisting of diphosphine (R₂P—X—PR₂), diphosphinite ((RO)RP—X—PR(OR)), diphosphonite ((RO)₂P—X—P(OR)₂), diphosphite ((RO)₂—P—OXO—P(OR)₂), diphosphinate, diphosphonate, diphosphate compound and a compound of the formula (RO)ₘR₂₋ₘP—XP(OR)ₘR₂₋ₘ wherein R denotes hydrogen, C₁ to C₁₀₀ alkyl group or a C₆ to C₁₄ aryl group, m is 0, 1 or 2 and X is a group of the formula (2) 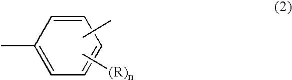
or of the formula (3) 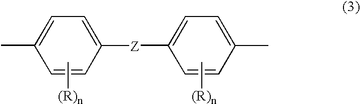
wherein R in formulas 2 and 3 represents phenyl, methyl, propyl, ethyl, butyl group, Cl or Br, n is 0, 1 or 2, and Z is a C₁ to C₈ alkylidene or C₅ to C₁₂ cycloalkylidene group, S, SO₂ or a single bond.

4. The composition according to claim 1, in which the organic phosphorus-containing compound conforms to 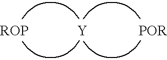
wherein R denotes hydrogen, C₁ to C₁₀₀ alkyl group or a C₆ to C₁₄ aryl group and Y represents a tetravalent C₁ to C₁₀₀ alkoxy group.

5. The composition according to claim 1 in which the phosphorus-containing compound is present in an amount of 10 ppm to 30 wt. %, with respect to the weight of the melt polymer.

6. The composition according to claim 1 in which the phosphorus-containing compound conforms to

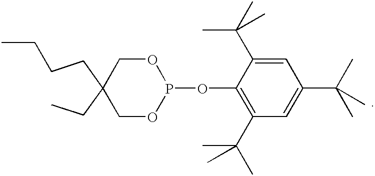

7. The composition according to claim 1 in which the phosphorus-containing compound conforms to

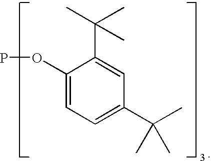

8. The composition according to claim 1 in which the phosphorus-containing compound is triphenylphosphane.

9. A molded article containing the composition according to claim 1.

10. A method of using the composition of claim 1 comprising molding an article by injection molding.
